(19) United States
(12) Patent Application Publication
(10) Pub. No.: US 2026/0185776 A1
(43) Pub. Date: Jul. 2, 2026

(54) SYSTEM FOR HEATING BILLETS OF NON-FERROUS MATERIALS

(71) Applicant: PRESEZZI EXTRUSION S.P.A., Vimercate (IT)

(72) Inventors: Mario BONIFACIO, Belgirate (IT); Valerio PRESEZZI, Lugano (CH)

(21) Appl. No.: 19/130,713

(22) PCT Filed: Dec. 20, 2023
(86) PCT No.: PCT/IB2023/062985

§ 371 Date: May 16, 2025

(30) Foreign Application Priority Data
Dec. 22, 2022 (IT) 102022000026502

(51) Int. Cl. F27B 9/38; C21D 9/00; F27D 3/04

(52) U.S. Cl. CPC F27B 9/38; C21D 9/0081; F27D 3/04

(57) ABSTRACT

A system for heating a metal billet made of non-ferrous material. The system includes a fixed base carrying at least one heating member or furnace configured to contain the billet for the heating thereof. Movable gripping members are disposed on the base and have gripping arms configured to retain the billet during the heating in the furnace. Each gripping arm is associated with a corresponding support and actuation assembly. The gripping members are arranged at two opposite ends of the furnace and at least a first one of the gripping members is movable with respect to a second one of the gripping members along the base. Both gripping members are relatively movable with respect to each other. The first one of the gripping members has a support structure movable on the base and carries the second one of the gripping members, which is movable on the structure.

Forming an object of the present invention is a system adapted to heat at least one metal billet made of non-ferrous materials, with various lengths and diameters, according to the preamble of the main claim.

Systems of the type indicated above have been known long since. They comprise one or more heating members or furnaces adapted to heat the billets which, picked up from special supports or warehouses, are inserted and retained in such heating members. The latter may be of various types: for example there are known heating members or gas or electromagnetic and magnetic induction furnaces.

With particular but non-limiting reference the latter, they operate by exploiting known physical principle according to which by introducing a ferromagnetic or paramagnetic or diamagnetic or a conductor metal body into a magnetic field, in such body there are generated parasitic currents which lead to the heating of the metal body due to the Joule effect. This physical principle is used for heating metal billets (made of non-ferrous metals) with the aim of making them more pliable and therefore more malleable for example for a subsequent extrusion operation, or for a subsequent step of a thermal treatment process.

Furnaces of the type mentioned above may for example be of the magnetic induction type (like the one described in US2010/147833) or comprising permanent magnets carried by an annular body rotating in a coaxial electric motor (like the furnace described in WO2017/081532); such permanent magnets generate a rotary magnetic field which in turn, due to the Joule effect, causes the heating of the billet inserted into a cavity of the furnace.

The system object of the present invention preferably comprises a magnetic induction furnace and in particular a furnace of this type having a fixed body or cylindrical and tubular carcass containing an electric motor having an electric stator integrally joined with fixed carcass and an annular rotor which can be driven in rotation around a longitudinal axis thereof in said stator and in said fixed body. The annular rotor is integrally joined with a rotor body or tubular support carrying a plurality of permanent magnets arranged so as to define a cavity of the furnace having a longitudinal axis coincident with the rotation axis of the rotor and adapted to contain at least one billet to be heated, by magnetic induction, by rotating the annular rotor and by the rotor body. During the heating, the billet is retained by gripping members which prevent each rotation around the longitudinal axis thereof. This is required given that, in the absence of such gripping member, the billet would rotate or would tend to rotate around the longitudinal axis thereof due to the rotary magnetic field generated by the magnets carried by the rotor body. Furthermore, the billet could tend to lose alignment in the furnace. Such rotation and misalignment could therefore negatively interfere with the positioning of the billet in the furnace and with the procedure for heating the billet. Such rotation and misalignment would negatively impact the excellent heating of the billet.

The prior art systems adapted to heat metal billets are usually large in size, especially if they use gas to obtain such heating. In addition, especially for gas-supplied systems, are systems that are required to run continuously, with continuous cycle, and this entails high management costs.

Furthermore, prior art systems comprise countless components and therefore have high maintenance costs.

Lastly, in the systems mentioned above, it is observed that—during the heating—the billet extends and deforms dilating, and this could also cause, like the rotation mentioned above, an incorrect support of the billet in the furnace and therefore a displacement thereof with respect to an excellent heating position (the one along the axis of the furnace), as well as a possible damage to the support members or internal members of the furnace.

An object of the present invention is to provide a system for heating metal billets made of non-ferrous materials which is improved with respect to equivalent prior art systems.

In particular, an object of the invention is to provide a system for heating metal billets in which the deformation and the extension of the billets, which occur during the heating procedure thereof, are suitably considered and compensated so as not to negatively impact the desired heating of each billet and so as to avoid damaging the mechanical members with which the billet cooperates during the process to which it is subjected in the system or specific mechanical members of the system which carry out said heating.

Another object of the invention is to provide a system for heating metal billets that is small in size and that had lower management costs with respect to the corresponding prior art systems.

A further object of the invention is to provide a system which allows to heat metal billets made of non-ferrous materials in an excellent and even manner or with an excellent degree of thermalisation and that is to have the same temperature of the billets both along the diameter and the longitudinal axis thereof.

A further object of the invention is to provide a system of the type mentioned above which allows to have billet heating cycles which are quick and controlled in an excellent manner.

A further object of the invention is to provide a system in which each component thereof which heats the billets (furnace) can be cooled rapidly after each step for heating the billets.

Another object of the invention is to provide a system which can heat the metal billet in an automated fashion continuously controlling, during the heating step, the internal temperature of the billet and, after each heating, the surface heating of the billets so as to be able to proceed to a heating of the subsequent billets accurately and as a function of the given temperature measured on the outer surface of the previously heated billets.

These and other objects which shall be more apparent to the person skilled in the art are attained by a system according to the attached claims.

For a better understanding of the present invention, the following drawings are attached hereto, purely by way of non-limiting example, wherein:

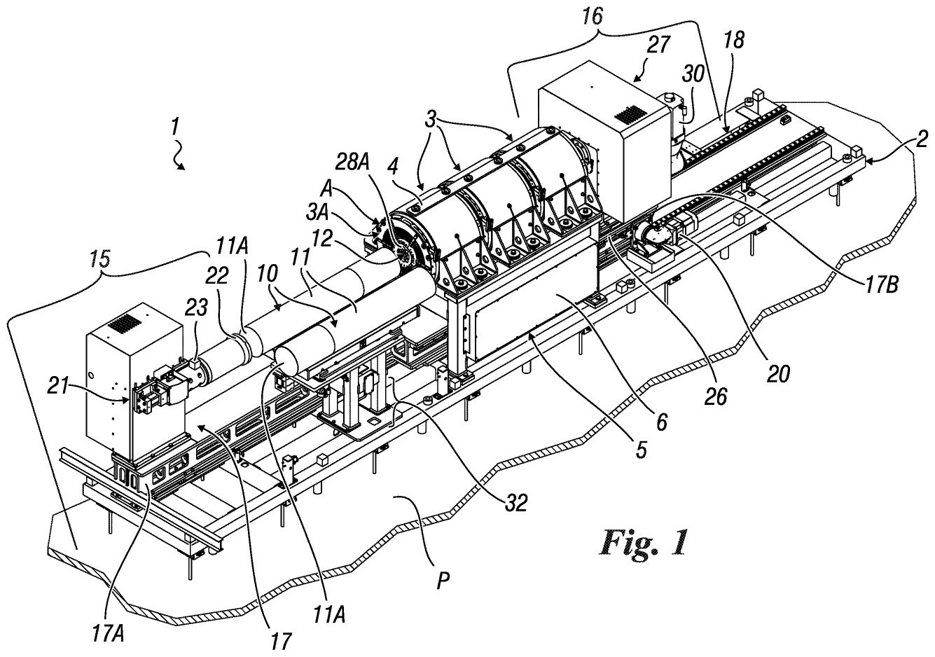

FIG. 1 shows a perspective view-from one side-of a system according to the invention in a first operative step;

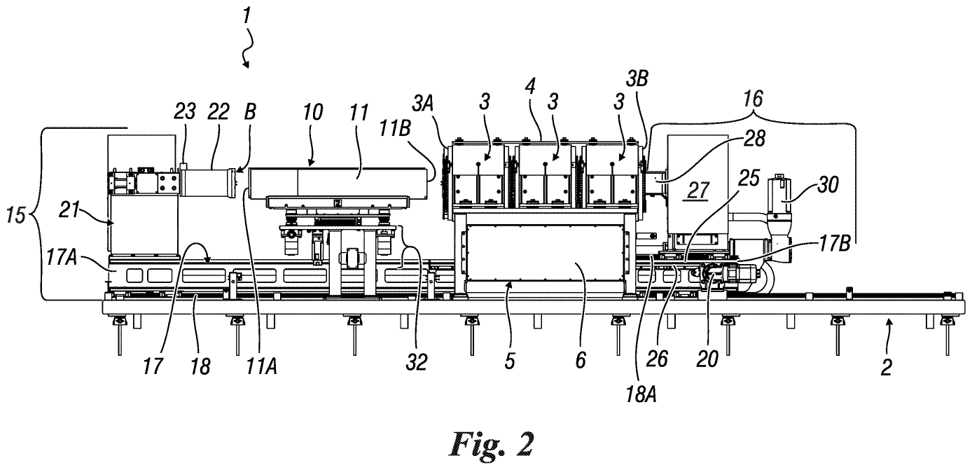

FIG. 2 shows a lateral view of the system of FIG. 1;

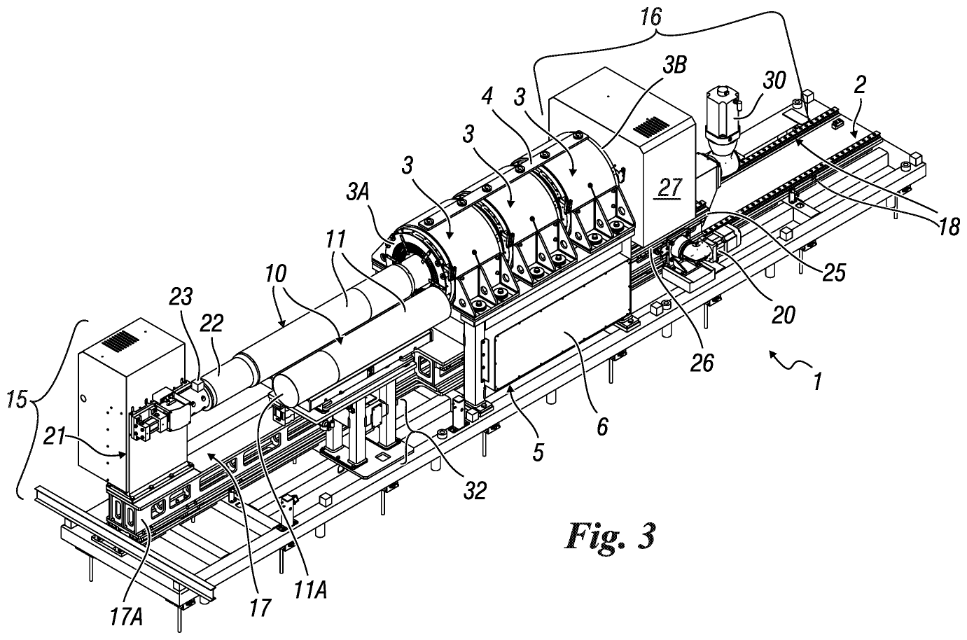

FIG. 3 shows a perspective view of the system of FIG. 1 in a second operative step;

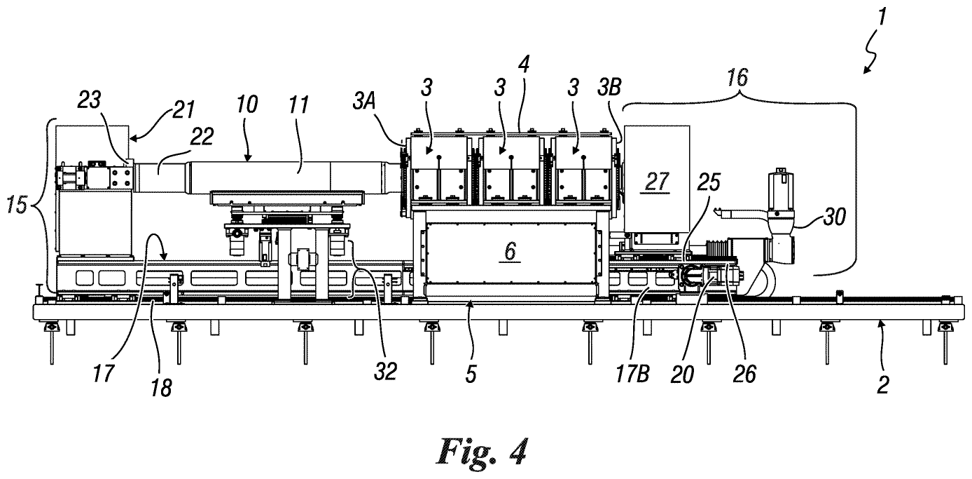

FIG. 4 shows a lateral view of the system of FIG. 3;

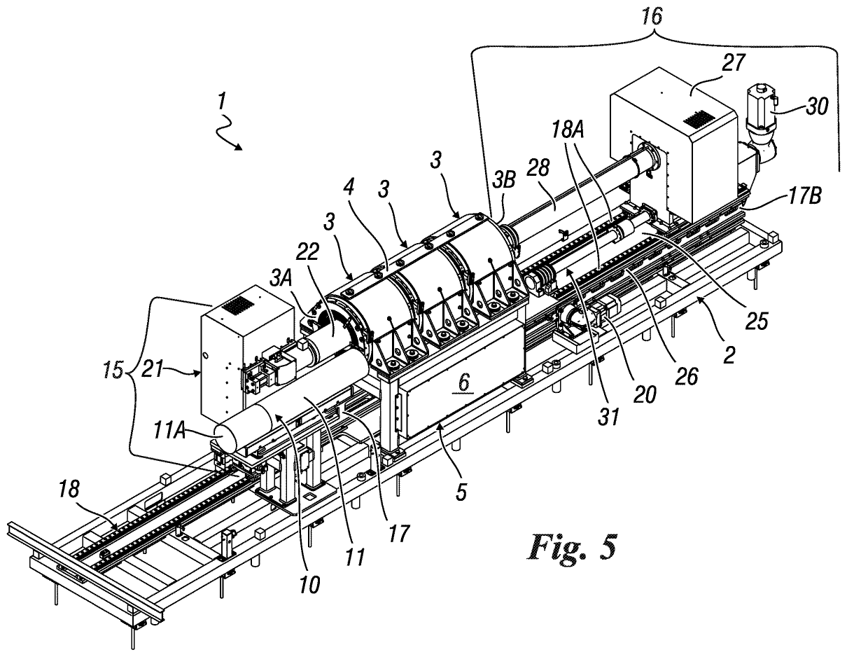

FIG. 5 shows a perspective view of the system of FIG. 1 in a third operative step;

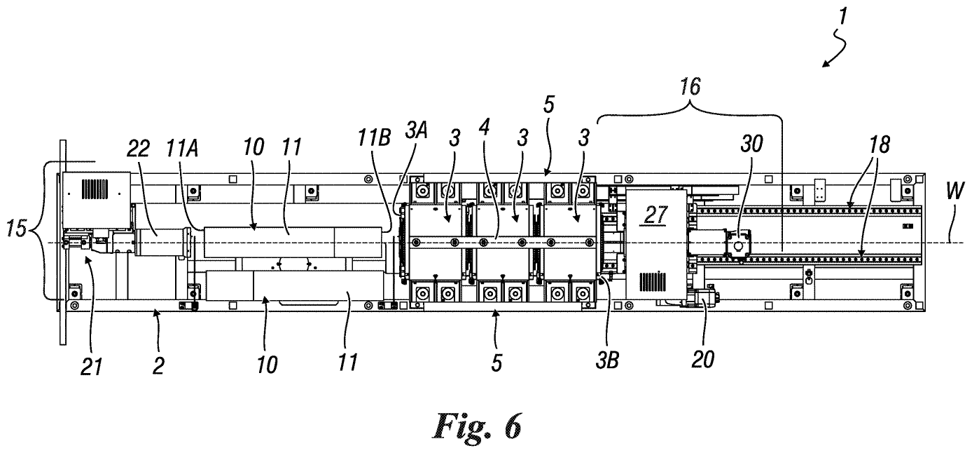

FIG. 6 shows a top view of the system of FIG. 1;

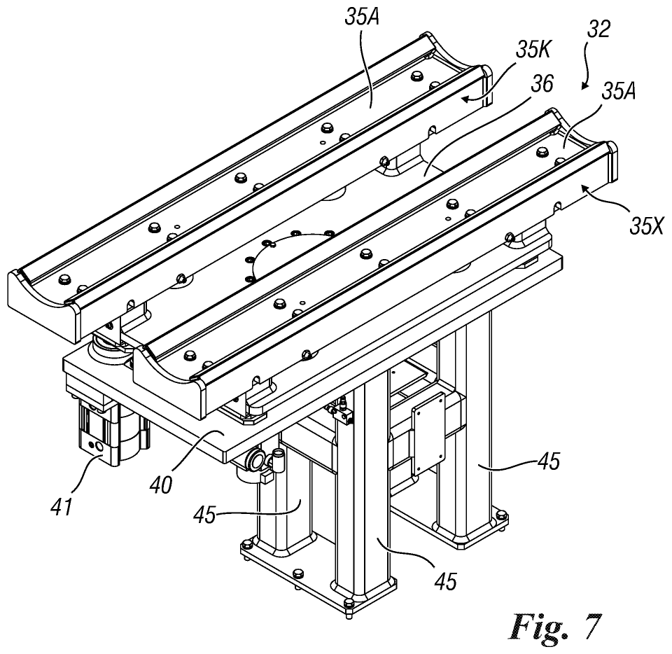

FIG. 7 shows a perspective view of a component of the system of FIG. 1;

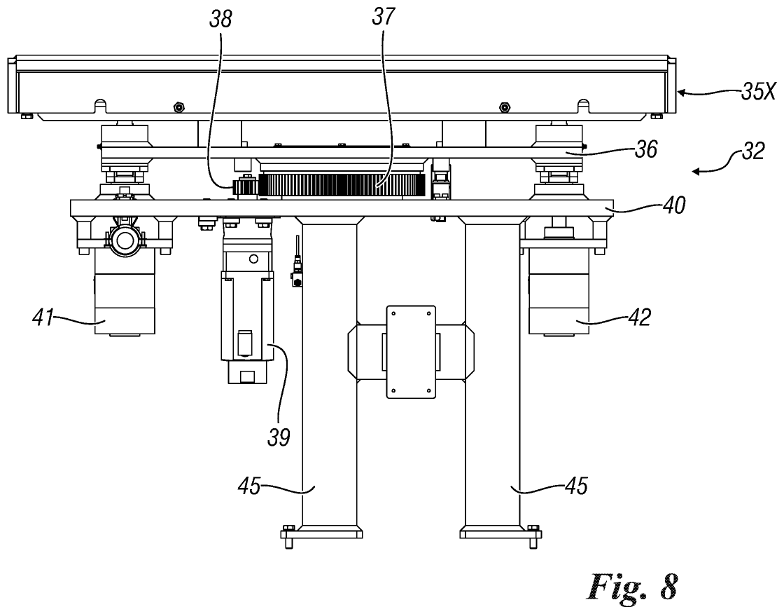

FIG. 8 shows a front view of the component of FIG. 7;

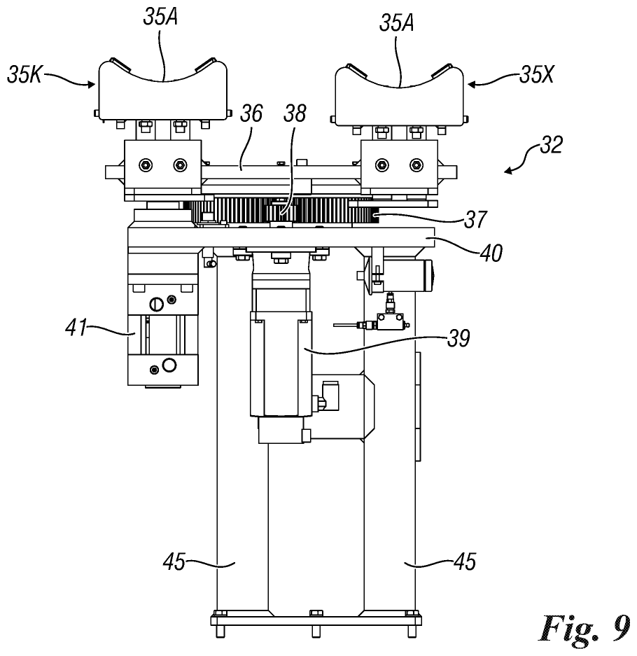

FIG. 9 shows a lateral view of the component of FIG. 7;

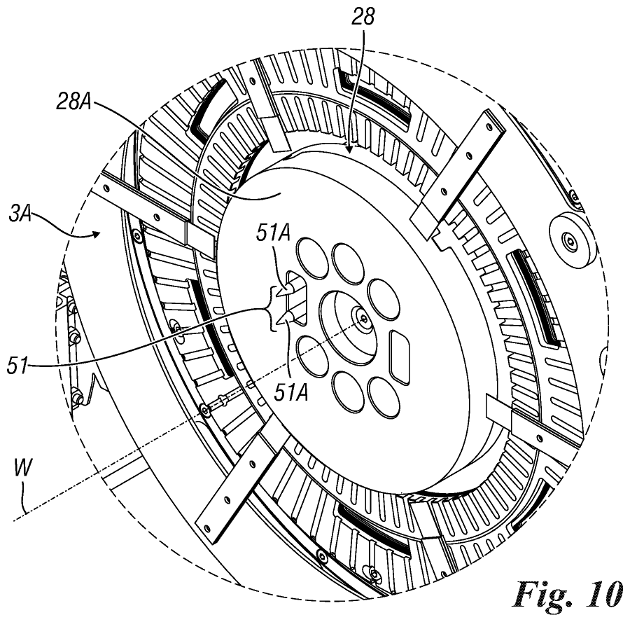

FIG. 10 shows an enlarged view of the detail indicated with A in FIG. 1;

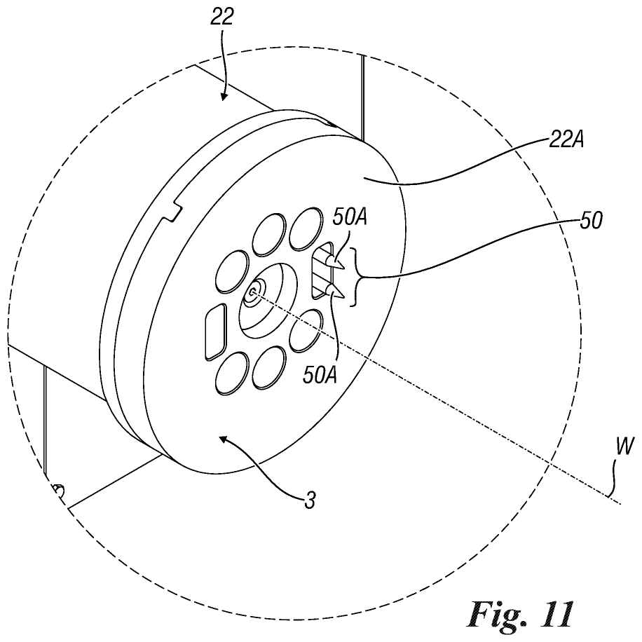

FIG. 11 shows a front view of the detail indicated with B in FIG. 2;

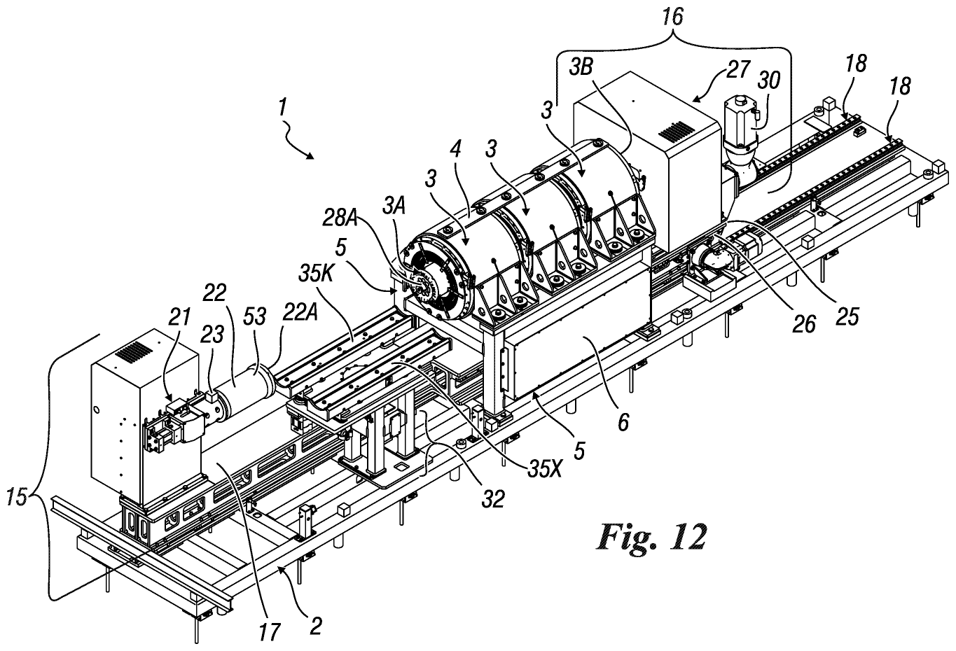

FIG. 12 shows a perspective view of the system of FIG. 1 with some parts omitted in a fourth operative step;

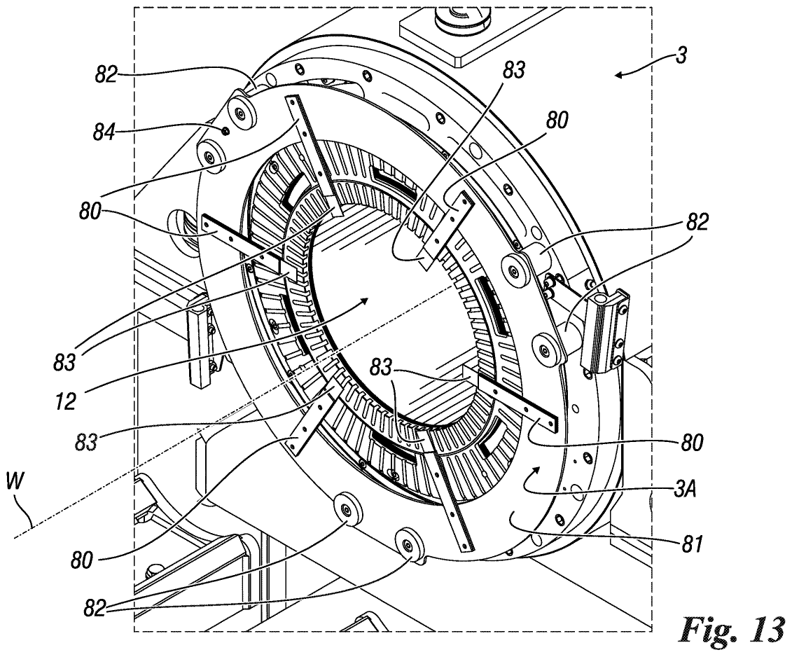

FIG. 13 shows a view similar to that of FIG. 10, but with some parts omitted to highlight a further component of the system according to the invention;

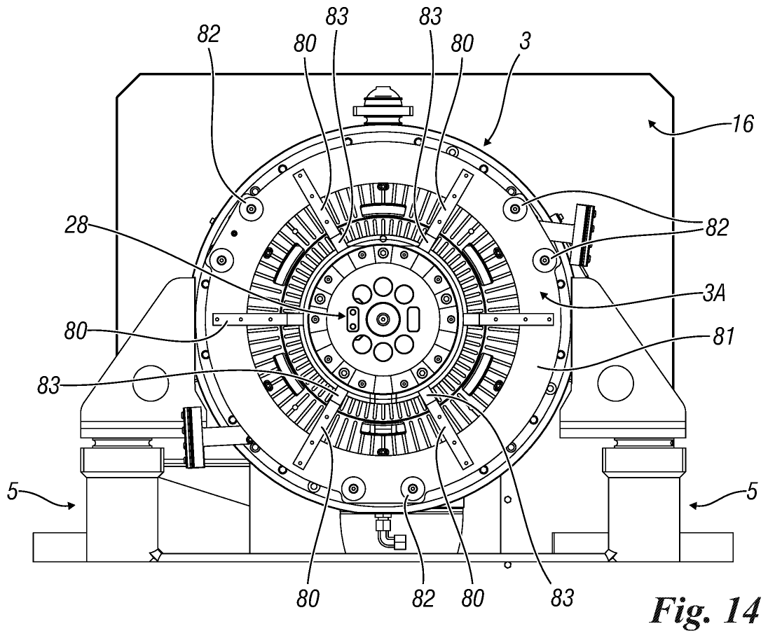

FIG. 14 shows a front view of the component of FIG. 13;

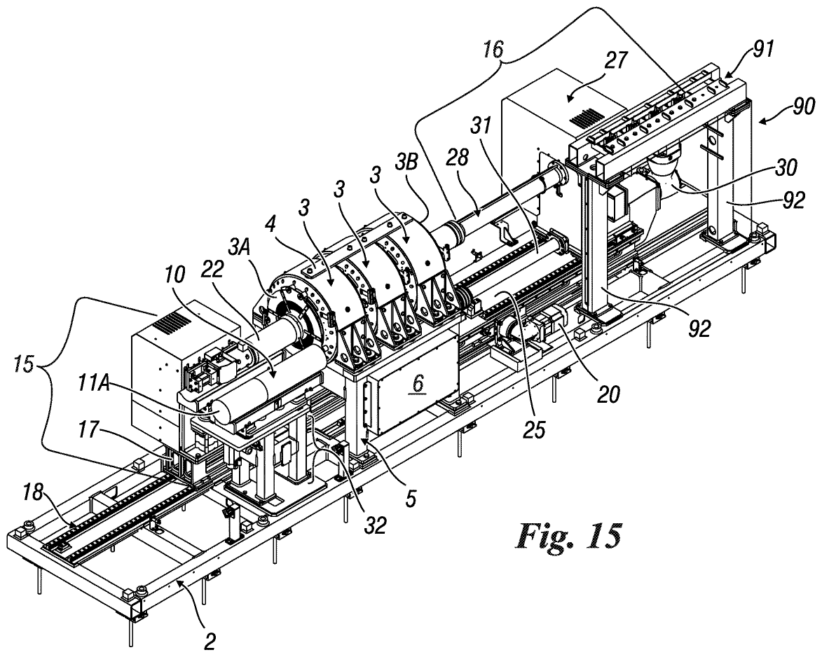

FIG. 15 shows a perspective view of the system of FIG. 1 with a further component;

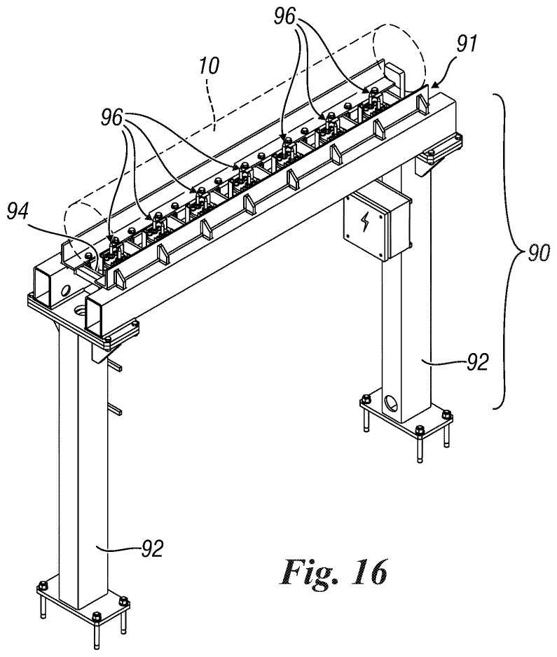

FIG. 16 shows a perspective view of the further component of FIG. 15;

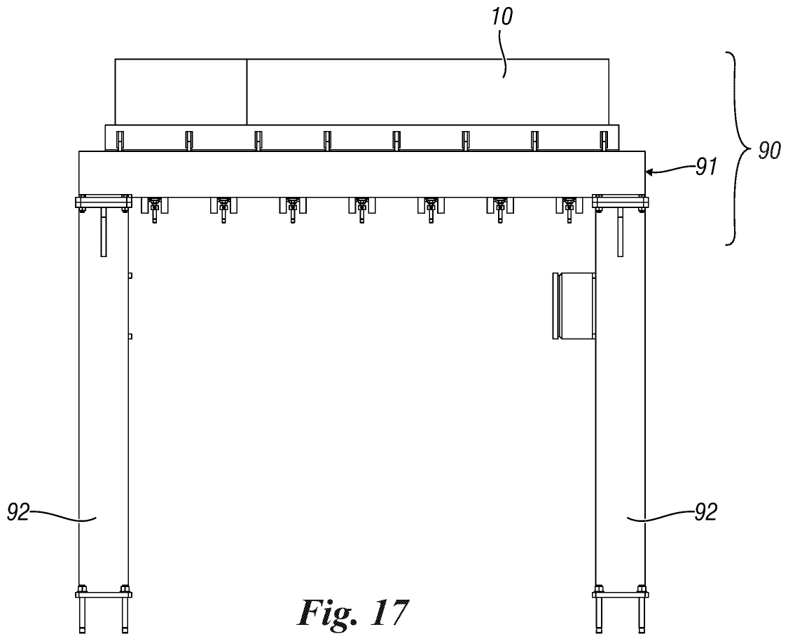

FIG. 17 shows a lateral view of the component of FIG. 15.

With reference to the aforementioned figures and in particular to FIGS. 1-6, 14 and 17, a system according to the invention is generally indicated with 1. It comprises a fixed base 2 supporting, in the example, three heating members defined-by way of example-by magnetic induction furnaces 3 arranged adjacent and consecutively to each other; such furnaces are “elastically” connected to each other (so as to reduce the vibrations) through an elongated flat body 4 which constrains the furnaces 3. Furthermore, the latter are elastically fixed to lateral supports 5 rising from the base 2 and mechanically integrally joined with the latter in any known manner. Such supports 5 also comprise chambers 6 containing members for the power supply of the heating members or magnetic induction furnaces 3.

Obviously, the system 2 may also provide for only one heating member or furnace 3 or a plurality of induction furnaces or with different embodiment (for example gas furnaces), said furnaces (or heating members) also possibly being more than three.

Such furnaces 3 are arranged with a common longitudinal axis W (see FIG. 6) horizontal or parallel to a plane or support P on which the system 1 (FIG. 1) lies and to which the base 2 is fixed.

According to the non-limiting (but preferred) embodiment shown in the figures, each furnace 3 is adapted to heat-by magnetic induction-a body 10 (by way of non-limiting example, an aluminium alloy billet) having a cylindrical body 11 (solid or hollow or tubular and of any cross-section). As will be described below, through components of the system 1, such body or billet 10 (hereinafter solely referred to as “billet”) is adapted to be positioned, in a part or cavity 12 of such furnace, at said cavity 12 there being provided for means adapted to generate, by magnetic induction, a radial and axial magnetic field and with variable intensity around and in the billet so as to create-in the latter-parasitic currents that cause the heating thereof up to a desired temperature, for example around 500° C. (in the case of aluminium alloys to be extruded) or greater (in the exemplifying cases of other non-ferrous materials such as copper, bronze, brass, silver, magnesium, titanium, or the alloy known by the name cupronickel, etc.).

The billet may be made of a single piece or defined by several parts of billet longitudinally associated with each other so as to define a body 11 with desired length.

A furnace of this type is for example described in WO2017/081532.

The cavity 12 of each furnace 3 is adapted to contain the billet 10 during the heating thereof without the latter being subjected to any rotary movement around the longitudinal axis thereof (coincident with the axis W) when in such cavity 12 there is generated the magnetic field for heating the billet by induction. Therefore, in order to avoid the rotation around the longitudinal axis thereof, the billet is retained in an absolutely fixed and stationary position in such cavity 12 during the heating thereof being supported by the components mentioned further above of the system 1.

The system 1 comprises two sections respectively defined by a first and a second gripping portion 15, 16 adapted to cooperate with each billet 10 so as to insert it into the “assembly” of the furnaces or heating members 3 and retain it when it is subjected to the heating caused by such furnaces. Such portions of the system, which hereinafter will be referred to as “gripping members 15, 16” are movable both relatively with respect to each other and with respect to the base 2. In particular, as described hereinafter, the gripping member 16 is movable with respect to the gripping member 15.

These gripping members allow an excellent retention of the billet 10 in each step of the “thermal treatment” thereof (including displacement, introduction into the furnaces 3, support during the heating and transfer outside said furnaces); furthermore, as will be clearer from the description that follows, such gripping members also allow to compensate the usual radial and longitudinal expansions of the billet subjected to heating.

Each portion of the system or gripping member 15, 16 comprises a plurality of components.

More particularly, a first gripping member 15 is arranged frontally at a first end 3A of the furnaces (or “group of furnaces”) 3, while the second gripping member 16 is arranged frontally at the second end 3B of such furnaces 3. The first gripping member 15 comprises a beam 17 arranged along the base 2 and below the furnaces 3, said beam being movable along the base 2 on a pair of linear guides 18 (or “first guide”) integrally joined with the base 2. Such movement is carried out through an electric motor 20 integrally joined with the base which activates a pinion cooperating with a rack 26 integrally joined with the beam 17 (see for example FIGS. 1, 2 and 5).

The beam 17 (or carriage or elongated structure) carries, (fixed) at a first end 17A thereof, an assembly 21 for supporting and actuating a first gripping arm 22 adapted to directly cooperate with a first end 11A of the body 11 of a billet to be heated. A second end 17B of the beam 17 carries the second gripping member 16 which is movable on said beam in an independent manner with respect thereto, as will be described below.

Therefore, the first gripping member 15 (or portion of system 15) comprises the beam 17 movable on guides 18 integrally joined with the base 2, the support and actuation assembly 21, and the first gripping arm 22 adapted to cooperate with the billet.

Such gripping member 15, as a whole (beam 17, assembly 21 and arm 22), moves on the base 2 thanks to the electric motor 20 which cooperates with the rack 26 fixed to the beam 17.

The second end 17B of the beam 17 of the first gripping member 15 supports a plane 25 on which there is arranged a second pair of guides 18A (see FIG. 5) on which there moves the second gripping portion of the system 16 which, like in the case of the first gripping portion 15, will hereinafter referred to as “second gripping member 16”. The latter comprising a plurality of components and in particular it comprises an assembly 27 for supporting and actuating a second gripping arm 28 adapted to directly cooperate with a second end 11B of the body 11 of the billet to be heated. Hereinafter, the assemblies 21 and 27 will be indicated as first and second support and actuation assembly, respectively. The gripping arms 22 and 28 are arranged in axis (coaxial) and they are arranged in axis with the cavity 12 of the furnace 3. Therefore, the arms 22 and 28 are arranged along the axis W (see FIG. 6).

The second support and actuation assembly 27 carries an electric motor 30 which drives a recirculating ball screw 31 whose rotation leads to the controlled movement of the entire second support and actuation assembly 27 on the plane 25. Therefore, the second gripping member 16 is arranged, movable along the pair of guides 18A, on the plane 25 carried by the beam 17 from the first gripping member.

Such second gripping member 16 comprises the support and actuation assembly 27 and the second gripping arm 28, as well as the electric motor 30 acting on the screw 31 which generate the movement of the second gripping member 16 (and, in particular, of the support and actuation assembly 27 of such gripping member 16) on the plane 25 mentioned above.

Therefore, the second gripping member 16 moves independently (specifically thanks to the electric motor 30 and to the screw 31) on the plane 25 of the first gripping member that is the second gripping member 16 moves independently on the first gripping assembly 15. Therefore, all components (27, 28,30) of the second gripping member 16 move independently with respect to the components 17, 21, 22 from the first gripping member 15.

In this manner, in particular, the first and the second gripping arm 22 and 28 are independent with respect to each other.

More particularly, with the movement of the second support and actuation assembly 27 of the second gripping member 16 on the plane 25 of the first gripping member 15, an end 28A of the second gripping arm 28 is introduced (see FIGS. 1, 10, 12) into each furnace 3 until it protrudes from the first end 3A of the furnace/s 3 with such vacant end 28A until it comes into contact with the second end 11B of the billet 10 to be heated arranged on a support 32 located frontally at the first end 3A of the furnace 3. The billet is therefore pushed by such gripping arm 28 against the first gripping arm 22.

It should be observed that the gripping arm 28 is integrally joined to the second support and actuation assembly 27, it is supported cantilevered on such assembly 27 (see FIG. 5) and it has a length sufficient to move with the vacant end 28A thereof outside the end 3A of the furnace 3 (for example see FIGS. 1 and 10) when the second support and actuation assembly 27 is positioned at the second end 3B of the furnace (by which it is penetrated, in the cavity 12, the second arm 28, see FIG. 1). This so as to contact the billet, push it against the first gripping arm 22 so as to tighten—in a clamp-like fashion—such billet between said arms 22 and 28 (see FIGS. 3 and 4).

Therefore, when the electric motor 30 is actuated, the recirculating ball screw 31 is activated and the second support and actuation assembly 27 of the second gripping member 16 moves (on the plane 25 of the first gripping member 15) along the pair of guides 18A and the second gripping member 28 penetrates into the furnaces 3 until the vacant end 28A thereof reaches outside the end 3A of the latter.

Therefore, such end contacts the billet 10 and pushes it against the first gripping arm 22 from the first support and actuation assembly 21 of the first gripping member 15. Therefore, the billet is clamped between such gripping arms 22 and 28.

The movement of the second support and actuation assembly 27 described above and the corresponding movement of the second arm 28 therefore allows the gripping and the fastening of the billet 10 to be carried into the furnaces 3. After the billet 10 has been clamped between the arms 21 and 28, activating the electric motor 20 enables to obtain (FIG. 5) the displacement of the beam 17 (and therefore of the first support and actuation assembly 21 and of the relative first gripping arm 22) of the first gripping member 15 along the base 2, with ensuing also second movement of the second gripping arm 28 of the second gripping member 16 carried by the beam 17 of said first gripping member 15 (which remained in the fixed position on the beam).

Given that the billet 10 is arranged along the axis W (on which the arms lie 22 and 28 and the cavity 10 of the furnaces 3, it being understood that such axis is a longitudinal axis of the billet, of said cavity and of the gripping arms), the movement of the beam 17 on the base 2 causes the driving of the billet 10 (“clamped” between the gripping arms 22 and 28) within the cavity of the furnaces 3, as shown in FIG. 5.

The translatory movement of the billet therefore is carried out safely and effectively.

The billet 10 is therefore retained by gripping arms 22 and 28 so that it cannot rotate around the longitudinal axis thereof when the furnaces 3 are activated, rotation generated by the rotary magnetic field present against the furnace 3.

It should be observed that the first gripping arm 21 cooperates with the load cell 23 (schematically shown in FIGS. 1-4 and 12) arranged in the first support and actuation assembly 21 of the first gripping member 15 adapted to verify the strength for clamping the billet between the gripping arms 22 and 28. A control unit of the system 1 (not shown), operating on all motors which move the gripping members 15 and 16, and connected to such load cell verifies the clamping strength of the billet and also controls the activation of the electric motor 30 to adjust the independent movement of the second gripping arm 28 with respect to the first gripping arm 22 so as to compensate each axial extension or deformation (along the longitudinal axis W) of the billet 10 subjected to heating.

As a matter of fact, during the heating, the billet 10 expands and extends. Such extension of the billet 10 is compensated by an automatic moving away of the second support and actuation assembly 27 of the second gripping member 16 from the furnaces 3 (that is of the second gripping arm 28 from the first 22). This is obtained automatically by providing for that the electric motor 30, which moves said second assembly 27 towards and from said furnaces 3, be adjusted or be run at a constant torque: in this case, the stress generated by the billet 10 (which extends during the heating) on the second gripping arm 28 leads to a “yielding” of the motor 30 which—running at a constant torque—enables the second support and actuation assembly 27 (and the corresponding arm 28) recedes (or moves away from the furnace 3); this allows the extension of the billet 10 during the heating step, while still enabling the same to be retained by gripping arms 22 and 28 which prevent the rotation thereof around the longitudinal axis thereof.

Thanks to the independent movement of the second gripping member 16 (which may move on the plane 25 associated with the beam 17) with respect to the first gripping member 15 and thanks to the translation kinematic mechanism of the beam 17 of the first gripping member 15 on the base 2, there is obtained an optimal movement and positioning of the billet 10 with respect to each furnace 3 and an optimal support thereof during the heating with automatic compensation of the extension thereof in such step and retention adapted to block the rotation thereof around the longitudinal axis thereof.

It should be observed that the actuator member (motor 20) of the first gripping member 15 allows, during the activation of the furnaces 3, to alternatively move the beam 17 on the base 2 in two opposite directions along the axis W generating a sort of pendulum effect of the billet in the furnaces 3 (without ever exiting therefrom). This enables an excellent hearing of the billet “spreading” the heating temperature along and therein, therefore obtaining an even and homogeneous heating billet despite the required distance present between the furnaces 3 not covered by the magnetic field which is generated in each furnace.

FIGS. 7-9 particularly show a support of the billets 32 which carries each billet 10 before and after the heating thereof.

Advantageously, as shown in FIGS. 1 and 3 for example, the support 32 may carry two billets 10 arranged adjacent but separated from each other: a first billet is arranged along the axis W, while the second is arranged parallel to the first. The billets are arranged in corresponding cradles 35K, 35X for example with semicircular seats 35A as shown, in turn carried by a rotary table 36. In the embodiment shown by way of non-limiting example, the rotary table 36 is integrally joined with a gear 37 driven by a pinion or gearwheel 38 driven by an electric motor 39 carried by a plane 40 underlying the rotary table.

Further actuators (linear, pneumatic or oil hydraulic) 41 and 42, carried to the plane 40, cooperate with the cradles 35K and 35X and they have the function of lifting said cradles. They allow to raise or lower the cradles 35K and 35X before or after the thermal treatment of the billet.

The actuators 41 e 42, for example hydraulic jacks, allow to move in the cradles 35K and 35X height-wise as a function of the temperature of the billet supported by each cradle. As a matter of fact:
a) when the billet is cold, the respective cradle which supports it positions it along the axis W or precisely in axis with the furnace 3;
b) when the billet is hot (for example upon exiting from the furnace), it is expanded (when it has a larger diameter or cross-section) and therefore the cradle which picks it up from the furnace must be lowered with respect to the axis W so as to correctly receive the billet which has expanded.

At the same time, the cradle which receives the billet before it is introduced into the furnace may take different positions (height-wise with respect to the axis W) as a function of the possible pre-heating to which the billet was subjected.

The actuators 41 and 42 therefore define the height compensation members of each cradle 35K, 35X as a function of the temperature of the billet, both before the entry into the furnace 3 and at the exit thereof.

Thanks to such conformation, the support 32 allows, through the known lifting/handling devices (not shown), to arrange the billet 10 on a first cradle 35K so that the billet is arranged along the axis W so that it is translated by the gripping arms 22 and 28 into the furnace/s 3 (or heating members). In the meantime, a second billet (loaded similarly on the support 32) “waits” on the cradle 35X thereof. At the end of the heating operation, the electric motor 20 is activated to move the beam 17 of the first gripping member 15 so as to remove the heated billet from the furnace 3 (held clamped by the arms mentioned above in any case).

The heated billet is therefore carried above cradle 35K thereof, which has been lowered with respect to the axis W in the meantime; therefore, the electric motor 30 and the second gripping arm 28 moves away from the billet which may thus be placed in the cradle thereof. The height-wise position of the cradle 35K depends on the temperature of the billet.

When the first previously heated billet is deposited in the cradle 35K thereof, the electric motor 39 is activated: thanks to the cooperation of the gears 37 and 38, the table 36 rotates by 180° carrying the second billet (on the cradle 35X) along the axis W and the first billet towards the external position of the system 1. From this position, in a known manner, the billet is removed from the support 32 and another billet is arranged in the cradle 35K thereof for the heating subsequent to that of the billet carried on the axis W now.

Therefore, the system 1 may operate substantially with a continuous cycle reducing machine downtime to the minimum.

The support 32 is constrained to the base 2 by uprights 45.

The system 1 allows to heat each billet in an excellent and controlled manner so as to activate each heating member or furnace 3 so as to bring each billet to the desired temperature (as a function of metallurgic characteristics, the material and subsequent use of the billet). This through the action of the control unit of the system which also operates as a function of the detection of the “internal” temperature of the billet (that is the temperature close to the axial central part of the billet) and the detection of the temperature present at the ends 11A and 11B of the billet.

This also allows to obtain the “conical temperature” in the billet, that is—as known—a distribution of the temperature which is higher at one end and drops linearly up to the other end. Such temperature distribution (conical) is also facilitated by the oscillating movement (pendulum effect described above) of the beam 17 in two opposite directions along the axis W which is activated during the step for heating the billet.

In order to have such temperature control, the gripping arms 22, 28 carry thermocouples 50, 51 (see FIGS. 10 and 11) with electrodes 50A and 51A which project (preferably elastically loaded) from their respective vacant ends 22A and 28A and contact the ends 11A and 11B of the billet. Such thermocouples 50 and 51 are close to the axis W along which the gripping arms mentioned above lie. They are connected to an electric circuit (not shown) which carries the detected temperature signals to the control unit mentioned above.

When the gripping arms 22 and 28 contact the ends of the billet, the electrodes 50A and 51A contact the ends 11A and 11B of the billet biting the metal material. With the heating of the billet in the furnaces 3, such material becomes softer and the electrodes (conical-shaped) penetrate thereinto allowing an excellent measurement of the temperature close to the axial central part of the billet.

This measurement allows to control the heating of the billet and therefore suitably control the furnaces 3 and the gripping members 15 and 16 to move the heated billet. The height of the cradle 35K, 35X which receives the billet upon exiting from the furnace 3 with respect to the axis W is also adjusted depending on the measured temperature.

It should be observed that at the first end 3A of the heating members or furnaces 3, that is of the end close to the support of the billets 32 there is present a detection device for detecting a non-coaxiality of a billet with the cavity 12 of the furnaces upon the insertion of such billet into the latter. Such detector device allows to prevent the insertion of a billet that is misaligned with respect to the longitudinal axis W in the cavity 12, an event that could lead to a contact between the first end 3A and the billet with the resulting damage caused to such end. The non-coaxiality due to an erroneous insertion of the billet into the cavity 12 leads to an ensuing contact with the part that delimits it and/or to an ensuing incorrect heating of the billet (which cannot rotate around the longitudinal axis thereof when it is inserted into the furnaces 3).

The detector device (see FIGS. 13 and 14) comprises a plurality of metal or in any case electrically conductor tabs 80 associated with a ring—also electrical conductor 81—supported by a plurality of insulating bushings 82 fixed on the first end 3A of the furnace 3. The tabs project towards the longitudinal axis W with the vacant ends 83 thereof, while the conductor ring is connected to a stabilised voltage power supply (not shown) through a wire (also not shown) fixed to the conductor ring in 84.

The vacant ends 83 of the metal tabs 80 delimit the maximum diameter for the billet to pass through towards the cavity 12 of the furnaces 3 if the billet is preferably arranged along the axis W. Should the billet not be perfectly in axis with such cavity 12, the billet 10 touches one or more metal tabs generating a short circuit between them and the mass of the furnace which is detected by a mass detector (not shown) in turn connected to the control unit of the system. In this case, such unit blocks the movement of the gripping members 15 and 16 and prevents the entry of the billet into the furnace. Therefore, such unit reverses the motion of the beam 17 which carries the gripping members 15, 16 moving the billet away from the end 3A.

Therefore, the movement of the billet can be excellently controlled through the detector device of FIGS. 13 and 14 after it has been clamped between the gripping arms 22 and 28 and before it is inserted into each furnace or heating member arranged on the base 2 of the system 1.

A further control of the system 1 and in particular of each heating member or furnace 3 thereof is obtained by detecting the distribution of the temperature on an outer surface of the billet 10 (or “skin temperature”) after it has been removed from the furnace. Such evaluation allows to control the heating of the subsequent billets and improve the heating quality of the controlled billet.

To this end, the system 1 comprises (see FIGS. 15-17) a structure 90 having a cradle 91 adapted to contain a billet 10 supported by columns 92.

The billet is loaded into the cradle 91 in any known manner through per se known lifting or handling devices.

Pairs of thermocouples 96 adapted to contact the surface of the billet at several points along the longitudinal axis thereof project from an inner surface 94 of the cradle 91. The thermocouples comprise electrodes 96A and 96B connected to the control unit of the system. The control unit determines the surface temperature of the billet 10 and the distribution thereof through the data detected by said thermocouples 96.

Based on the parameters stored, the control unit carries out a comparison of the detected current temperature with the one stored for several points of the billet. Therefore, the control unit detects whether the temperature distribution is the desired or undesired one for the type (material and size) of the heated billet examined, so as to maintain or change the heating parameters to which the billet is subjected to be used for the heating of subsequent billets, heating parameters that are identical or different from those of the examined billet.

Based on the detection of the temperature by the structure 90, the control unit of the system may change both the heating power of each furnace 3 and the heating time of the billet activating each furnace for appropriate periods of time and moving the beam 17 carrying the gripping members 15 and 16 for introducing and therefore removing the billets from the furnaces 3 at the right time.

The described system 1 may operate in a fully automated fashion and continuously therefore allowing to have high production rates and excellently heated products (billets).

As described, the system has a base 2 on which there may move a first gripping member 15 having a beam 17 directly movable on the base and carrying a first support and actuation assembly 21 to which there is associated a first gripping arm 22. Such first gripping member 15, on a plane 25 thereof supported by the beam 17, carries a second gripping member 16 movable along guides 18A integrally joined with such plane 25. The second gripping member 16, in particular, comprises a second support and actuation assembly 27 with which a second gripping arm 28 is associated.

The second gripping member comprises an electric motor 30 which allows the displacement thereof along the guide 18A in an independent manner on the plane 25 and therefore on the first gripping member which is a component of such plane 25.

The gripping arms 22 and 28 are adapted to retain the billet 10 in a furnace 3. Should this be of the type adapted to heat the (metal) billet through a rotary magnetic field into which the billet is submerged, the billet also tends to rotate around the longitudinal axis thereof. The gripping arms 22 and 23 prevent such rotation for a safe heating of the billet.

Furthermore, given that the second gripping member 16 is movable on the and with respect to the first gripping member 15 in an entirely independent manner, it is possible to relatively move the second gripping member 28 with respect to the first gripping arm 22 during the heating of the billet so as to compensate each extension or deformation of the billet. This without the billet being released by said gripping arms 22, 28.

Such relative movement between the second gripping member 16 and the first gripping member 15 allows to adapt to any length of the billet.

Therefore the invention allows to heat a billet compensating the deformation or extension thereof during the heating step so as to prevent, besides the metallurgic problems linked to the crystalline structure of the material, the billet from deforming making it subsequently unusable in a subsequent extrusion operation or damaging a furnace 3 or the components (gripping arms) of the gripping members 15 and 16 which retain it.

Specifications embodiments of the system and its components have been described above. Obviously, a system for heating billets may be provided by way of example with respect to the one described above: for example, it may even not have members for measuring the temperature of a billet during heating and/or subsequently to such operation, just like it may also comprise other components such as the device for detecting the coaxiality of the billet with the cavity of the furnaces 3. Just like the system 1 may comprise only one magnetic electrical induction heating member.

Even these variants comprise of the characteristics of the invention as defined by the claims that follow.

1-15. (canceled)

16. System for heating a metal billet comprising a fixed base carrying at least one heating member having a cavity configured to house the billet during the heating thereof, and first and second gripping members disposed on the base and being configured to retain the billet during the heating in the heating member, the first and second gripping members being arranged at opposite first and second ends of said heating member, wherein the first and second gripping members are movable with respect to the base, the first gripping member comprising a beam arranged under the base and under the heating member, said beam being movable in a guided fashion along the base, the beam having a first end arranged at a first end of the heating member and supporting a first gripping arm configured to cooperate with a first end of the billet and associated with a first support and actuation assembly fixed to the beam, said first gripping arm and said first support and actuation assembly being components of the first gripping member, the beam having a second end arranged at the second end of the heating member and supporting a plane on which there is arranged movable in a guided fashion the second gripping member, said second gripping member comprising a second gripping arm configured to cooperate with a second end of the billet and associated with a second support and actuation assembly of said second gripping member, said second support and actuation assembly being movable in a guided fashion on said plane carried by the beam from the first gripping arm under the action of actuation means, said first and said second gripping arms retaining the billet when it is arranged in the heating member so as to avoid the rotation thereof around a longitudinal axis (W) thereof, said first and second gripping arms being operable to automatically move apart during the retention of the billet so as to compensate each deformation and extension of the billet during the heating thereof in the heating member, said first and second gripping members being arranged coaxial with a longitudinal axis (W) of the cavity of the heating member.

17. System according to claim 16, wherein the beam moves along a first guide arranged on said base, and wherein a rack is joined to the beam and cooperates with an actuator joined to the base to move the beam along the base.

18. System according to claim 16, wherein said plane is integrally joined with the beam of the first gripping member and has a guide along which the second support and actuation assembly of the second gripping member moves, said movement being generated by an actuator integrally joined with said second support and actuation assembly.

19. System according to claim 18, wherein said actuator comprises an electric motor adjusted with constant torque configured to allow an automatic moving away of the second gripping member from the first gripping member following a longitudinal extension of the billet during heating.

20. System according to claim 16, wherein said gripping arms comprise measuring devices for measuring the temperature of one part of the billet close to a central axial area of the billet.

21. System according to claim 20, wherein said measuring devices comprise thermocouples with electrodes protruding from vacant ends of said first and second gripping arms and configured to cooperate with corresponding opposite ends of the billet, said thermocouples being close to the longitudinal axis (W) of said heating member and the first and second gripping arms.

22. System according to claim 16, wherein the system comprises a support for a plurality of billets arranged between the first gripping member and the heating member, said support comprising a rotatable table carrying a plurality of cradles for a corresponding plurality of billets.

23. System according to claim 22, wherein said cradles are movable vertically with respect to the longitudinal axis (W) of the cavity of the heating member, and wherein the system comprises members for compensating the position of said cradles as a function of the temperature of the billet.

24. System according to claim 16, comprising conductor tabs at the first end of the heating member, at which the billet is introduced into the cavity of said heating member, the conductor tabs protruding towards said cavity from a support at the first end of the heating member and electrically supplied, said conductor tabs delimiting an access opening for entry of the billet into said cavity, said access opening being coaxial with said cavity, said support being fixed to said first end of the heating member through a plurality of insulating bushings, wherein contact of the billet with said conductor tabs generates an electrical signal indicating a misalignment of the billet with said cavity.

25. System according to claim 16, wherein the system comprises detector means for detecting the surface temperature along a billet after the heating thereof.

26. System according to claim 25, wherein said detector means comprise a structure having a cradle and supported by load-bearing members, said cradle being configured to receive a billet after the heating thereof, a plurality of thermocouples protrude from an inner surface of said cradle, the plurality of thermocouples is configured to contact the surface of the billet in a plurality of points along the longitudinal axis thereof and to measure the temperature of such surface.

27. System according to claim 16, wherein the system comprises a unit for controlling the operation thereof configured to control the displacement of the first and second gripping members and the activation of the heating member as a function of the temperature detected by the billet.

28. System according to claim 16, wherein said billet comprises billet parts longitudinally associated with each other so as to define a body with a desired length, the billet parts being maintained longitudinally associated with each other by said first and second gripping members during the heating.

29. Method for heating a metal billet, comprising:
providing a system comprising a base carrying at least one heating member having a cavity configured to house the billet during the heating thereof, and first and second gripping members disposed on the base and including first and second gripping arms configured to retain the billet during the heating in the heating member, the first and second gripping members being respectively arranged at first and second opposite ends of said heating member, the first gripping member being movable with respect to the base of the system, the first gripping member supporting the second gripping member so that said second gripping member is movable on a plane of the first gripping member, said first and second gripping members retaining the billet when it is inserted into the heating member;
compensating the extension or deformation of the billet during heating by relatively moving apart the first and second gripping members along a longitudinal axis (W) of the billet;
maintaining the first gripping member in a locked position on said base using the second gripping member; and
moving said second gripping member in a guided fashion on said plane of the first gripping member so that the second gripping arm does not detach from the billet while allowing the deformation or extension thereof.

30. Method according to claim 29, wherein, during the activation of the heating member or furnace, alternately moving the first gripping member on the base in two opposite directions along the longitudinal axis of the billet, said moving occurring while maintaining the second gripping member fixed on the first gripping member, the moving of the first gripping member therefore also causing moving of the second gripping member with respect to the furnace.

31. The system according to claim 16, wherein said billet is made of a single piece.
